(19) United States
(12) Patent Application Publication
(10) Pub. No.: US 2009/0133828 A1
(43) Pub. Date: May 28, 2009

(54) METHOD AND SYSTEM FOR MAKING AN INFLATABLE BED

(76) Inventor: Hsin-Tsai WU, Taipei City (TW)

Correspondence Address: NIXON & VANDERHYE, PC, 901 NORTH GLEBE ROAD, 11TH FLOOR, ARLINGTON, VA, 22203, US

(21) Appl. No.: 12/262,495

(22) Filed: Oct. 31, 2008

(30) Foreign Application Priority Data
Nov. 23, 2007 (CN) 200710031767.0

(51) Int. Cl. B32B 37/04; B29C 65/02

(52) U.S. Cl. 156/294; 156/423

(57) ABSTRACT

A method for making an inflatable bed includes the steps of: sleeving a plurality of tubular tension members onto a guide bar; placing a bottom plastic sheet on a carrier that has a plurality of aligned through holes extending through top and bottom surfaces of the bottom plastic sheet; laying the guide bar on the bottom plastic sheet with the guide bar being aligned with the aligned through holes and with each of the tubular tension members being aligned with one of the through holes; laying a top plastic sheet on the guide bar and the bottom plastic sheet; and welding the tubular tension members to the top and bottom plastic sheets. A system for making an inflatable bed is also disclosed.

### CROSS-REFERENCE TO RELATED APPLICATION

This application claims priority of Chinese Application No. 200710031767.0, filed on Nov. 23, 2007.

### BACKGROUND OF THE INVENTION

1. Field of the Invention

This invention relates to a method and system for making an inflatable bed.

2. Description of the Related Art

Referring to FIGS. 1 and 2, a first conventional method for making an inflatable bed involves the steps of preparing a plurality of independent molds 11 and a plurality of PVC tubular tension members 12, and inserting each mold 11 into a respective one of the tubular tension members 12. A PVC bottom sheet 14 is placed on a lower platen 22 of a high-frequency welding machine 2, after which the molds 11, which are inserted into the respective tubular tension members 12, are arranged manually on the bottom sheet 14. A PVC top sheet 13 is then placed on the tubular tension members 12, so that the molds 11 and the tubular tension members 12 are disposed between the top and bottom sheets 13, 14. Subsequently, the welding machine 2 is actuated so as to move downwardly an upper platen 21 thereof that is disposed above the top sheet 13 so that the upper and lower platens 21, 22 press respectively the top and bottom sheets 13, 14. High-frequency heat is then transmitted to the upper and lower platens 21, 22 to weld top and bottom ends of the tubular tension members 12 to the top and bottom sheets 13, 14, respectively. The molds 11 are removed from the respective tubular tension members 12 after the welding.

Because the molds 11 are arranged on the bottom sheet 14 manually, the positions of the molds 11 can be deviated so that positional errors will be produced with respect to the tension members 12 in the final obtained inflatable bed 3 (see FIG. 3). This results in the supporting effect of the top and bottom sheets 13, 14 and the tension members 12 being nonuniform and unstable. Since the molds 11 are pressed between inner faces of the top and bottom sheets 13, 14, a pattern produced by the pressing of the molds 11 does not clearly appear on outer faces of the top and bottom sheets 13, 14, so that the entire appearance of the inflatable bed 3 is unappealing. Moreover, work efficiency suffers as a result of the manual placement of the molds 11 on the bottom sheet 14.

Referring to FIG. 4, a second conventional method for making an inflatable bed includes the steps of providing a plurality of mold units 10 (only one is shown), each of which includes a plurality of spaced-apart molds 11, and a plurality of tubular tension members 12 sleeved onto each mold unit 10 so as to surround respectively the molds 11. This method can overcome some of the drawbacks encountered in the aforementioned first conventional method. However, since the arrangement of the mold units 10 on the bottom sheet must still be done manually and with care to prevent positional deviations of the mold units 10, work efficiency still cannot be enhanced. Further, in the second conventional method, the molds 11 are also pressed between the inner faces of the top and bottom sheets, so that the resulting inflatable bed has no clearly discernible pattern, and is therefore unappealing. Moreover, the molds 11 in each mold unit 10 are interconnected in series by using a metal strip, so that the weight of each mold unit 10 is increased.

In each of the first and second conventional methods, continuous high-frequency heating results in an accumulated temperature of about 40° C., such that injury to the hand of an operator is likely to occur.

### SUMMARY OF THE INVENTION

Therefore, the object of the present invention is to provide a method and a system for making an inflatable bed that are capable of overcoming the aforementioned drawbacks of the prior art.

According to one aspect of this invention, a method for making an inflatable bed comprises the steps of: sleeving a plurality of tubular tension members onto a guide bar; placing a bottom plastic sheet on a carrier that has a plurality of aligned through holes extending through top and bottom surfaces of the bottom plastic sheet; laying the guide bar on the bottom plastic sheet with the guide bar being aligned with the aligned through holes and with each of the tubular tension members being aligned with one of the through holes; laying a top plastic sheet on the guide bar and the bottom plastic sheet; and welding the tubular tension members to the top and bottom plastic sheets.

According to another aspect of this invention, a system for making an inflatable bed, which has top and bottom plastic sheets, and a plurality of tubular tension members disposed between and welded to the top and bottom plastic sheets, comprises a lower platen having a plurality of lower dies projecting upwardly from the lower platen, an upper platen disposed above the lower platen and having a plurality of upper dies projecting downward y from the upper platen and alignable with the lower dies, a carrier to be disposed on the lower platen, and a guide bar. The carrier has top and bottom surfaces, and a plurality of aligned through holes extending through the top and bottom surfaces, and is adapted to support the top and bottom plastic sheets. The guide bar is to be disposed on the carrier in alignment with the aligned through holes, and is adapted to extend into the tubular tension members. The lower dies are extendable into the respective through holes when the carrier is disposed on the lower platen. The upper platen is movable downward and toward the carrier and the lower platen to press the upper and lower dies against the guide bar so that the tubular tension members disposed on the guide bar are pressed between the top and bottom plastic sheets.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a mold and a tubular tension member used in a first conventional method for making an inflatable bed;

FIG. 2 is a perspective view of a welding machine used in the first conventional method;

FIG. 3 is a perspective view of the inflatable bed made using the first conventional method, with a portion of the inflatable bed removed for clarity's sake;

FIG. 4 is a perspective view of a mold, with a plurality of tubular tension members sleeved thereon, used in a second conventional method for making an inflatable bed;

FIG. 5 is a flow chart, illustrating the steps involved in a method for making an inflatable bed according to the preferred embodiment of the present invention;

FIG. 6 is a schematic view of an assembly of a guide bar and a plurality of tubular tension members used in a system for making the inflatable bed according to the preferred embodiment of the present invention;

FIG. 7 is a perspective view of a carrier used in the system of the present invention;

FIG. 8 illustrates top and bottom plastic sheets and assemblies of guide bars and tension members being placed on the carrier;

FIG. 9 is a schematic side view of a welding machine and a platform used in the system of the present invention;

FIG. 10 is a sectional view of the welding machine taken along line X-X of FIG. 9;

FIG. 10A is a perspective view of a die of the welding machine;

FIG. 10B is a perspective view of another configuration of a die of the welding machine;

FIG. 10C is a perspective view of still another configuration of a die of the welding machine;

FIG. 11 illustrates how top and bottom plastic sheets are pressed by upper and lower dies of upper and lower platens of the welding machine;

FIG. 12 is an enlarged sectional view of the preferred embodiment, illustrating how the upper and lower dies press the top and bottom plastic sheets;

FIG. 13 illustrates the upper platen of the welding machine being moved upwardly so as to permit removal of the carrier from the lower platen of the welding machine; and

FIG. 14 is a perspective view of the inflatable bed made according to the method and system of the preferred embodiment.

### DETAILED DESCRIPTION OF THE PREFERRED EMBODIMENT

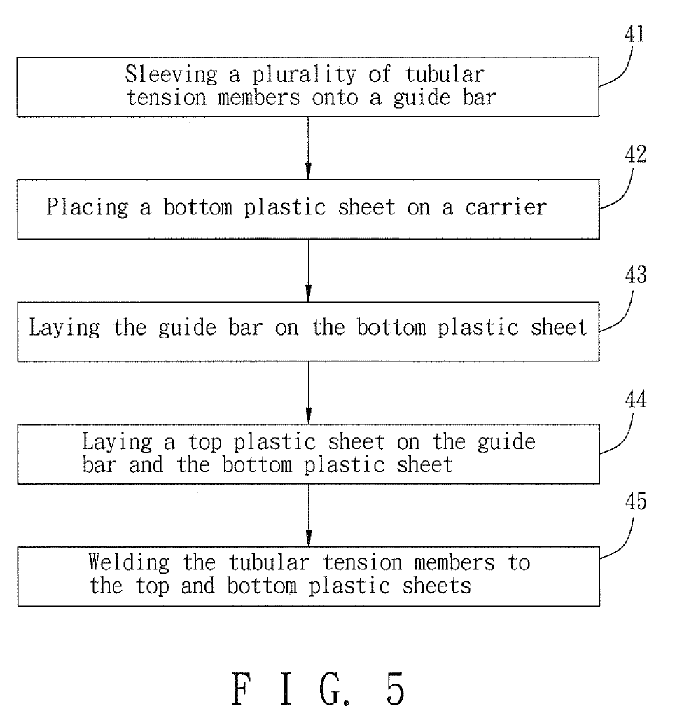

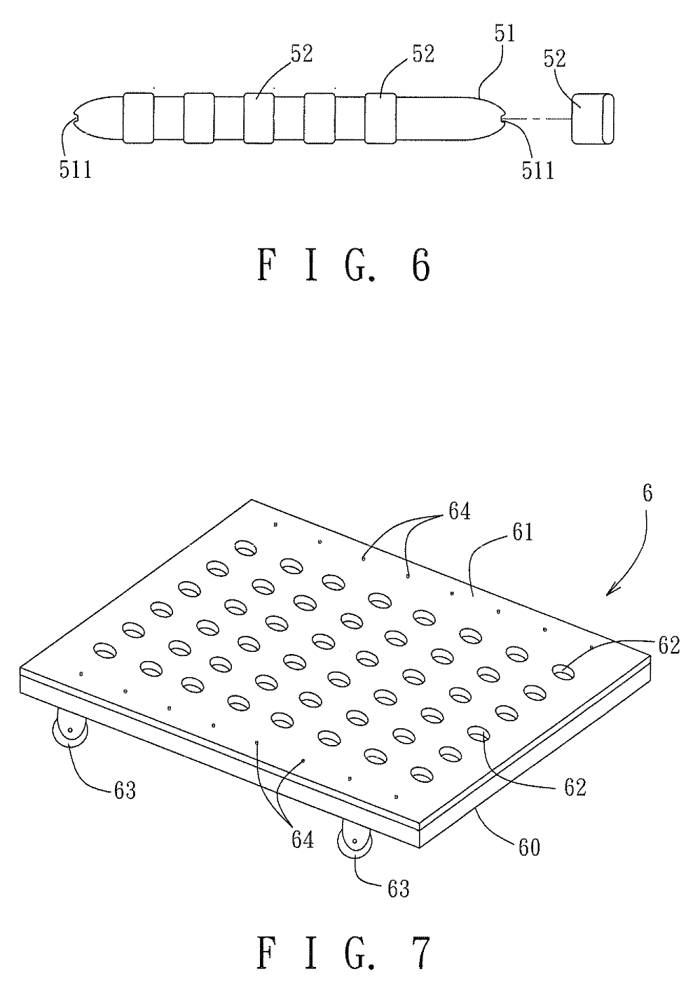

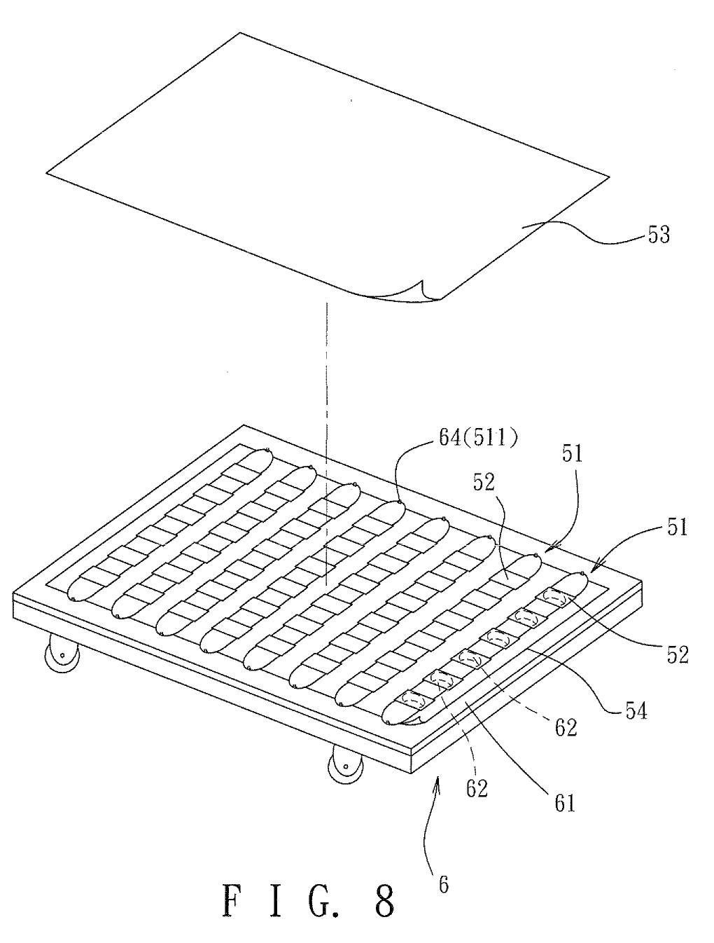

Referring to FIG. 5, a method for making an inflatable bed 5 (see FIG. 14) according to the preferred embodiment of the present invention is shown to comprise steps 41 to 45. These steps are carried out using a system of the present invention shown in FIGS. 6 to 13. The system of the present invention comprises a plurality of guide bars 51 (see FIG. 8), a carrier 6, a high-frequency welding machine 7, and a platform 8.

In step 41, with reference to FIG. 6, the tubular tension members 52 are sleeved onto one of the guide bars 51, and are equally spaced apart from each other along the length thereof. Each guide bar 51 has two opposite ends respectively provided with first engaging elements 511. The carrier 6, as shown in FIG. 7, has top and bottom surfaces, a plurality of rows of aligned through holes 62 extending through the top and bottom surfaces 61, 60 and equally spaced apart from each other in longitudinal and transverse directions of the inflatable bed 5, a plurality of spaced-apart rollers 63 attached to the bottom surface 60, and a plurality of spaced-apart second engaging elements 64 respectively engageable with the first engaging elements 511 and provided on the top surface 61 in such a manner that a pair of the second engaging elements 64 are present on two opposite sides of each row of the aligned through holes 62.

In steps 42 to 44, with reference to FIG. 8, a bottom plastic sheet 54 is placed on the top surface 61 of the carrier 6, and is surrounded by the second engaging elements 64. The guide bars 51 with the tubular tension members 52 are then laid on the bottom plastic sheet 54 in such a manner that each guide bar 51 is aligned with the respective row of the through holes 62, and each tubular tension member 52 is aligned with and is disposed above a respective one of the through holes 62. Since the length of each guide bar 51 is longer than a width of the bottom plastic sheet 54, the first engaging elements 511 (see FIG. 6) of each guide bar 51 are located at the outside of the bottom plastic sheet 54 and engage the second engaging elements 64, respectively, thereby positioning each guide bar 51 on the top surface 61 of the carrier 6. A top plastic sheet 53 is then laid on the guide bars 51 and the bottom plastic sheet 54.

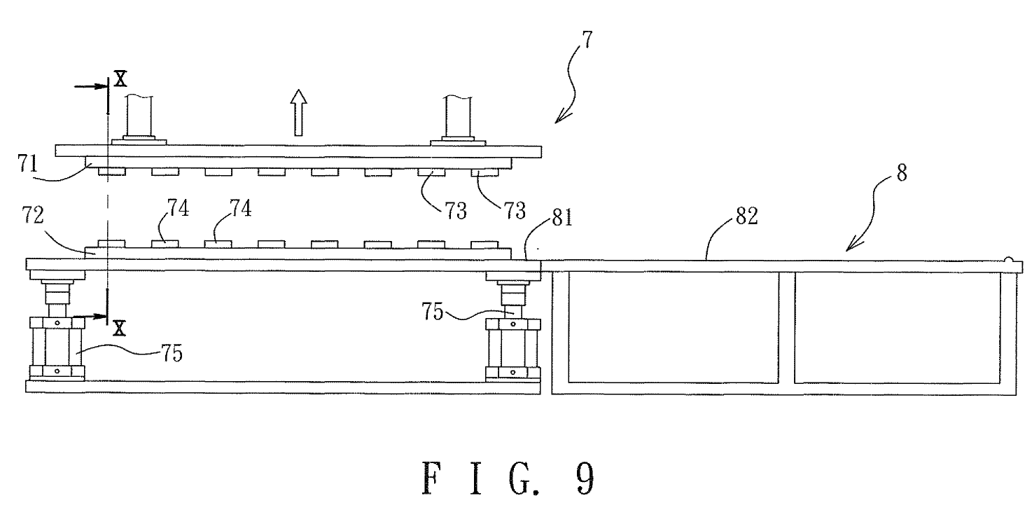

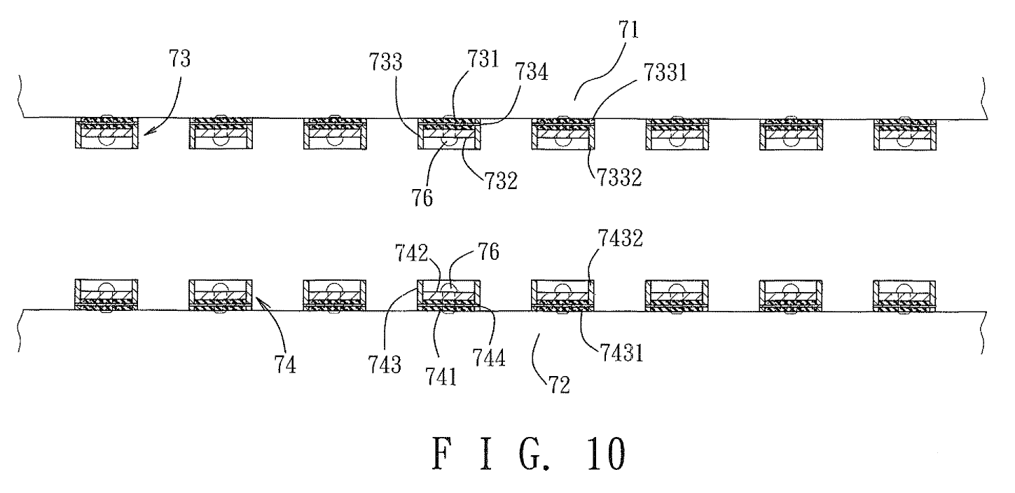

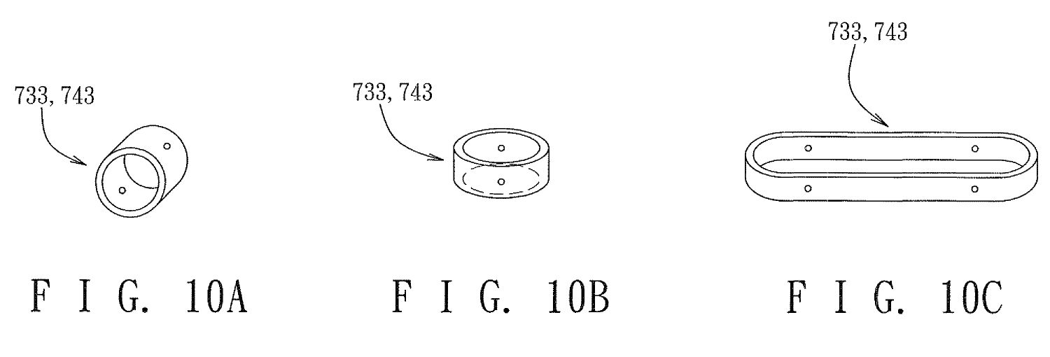

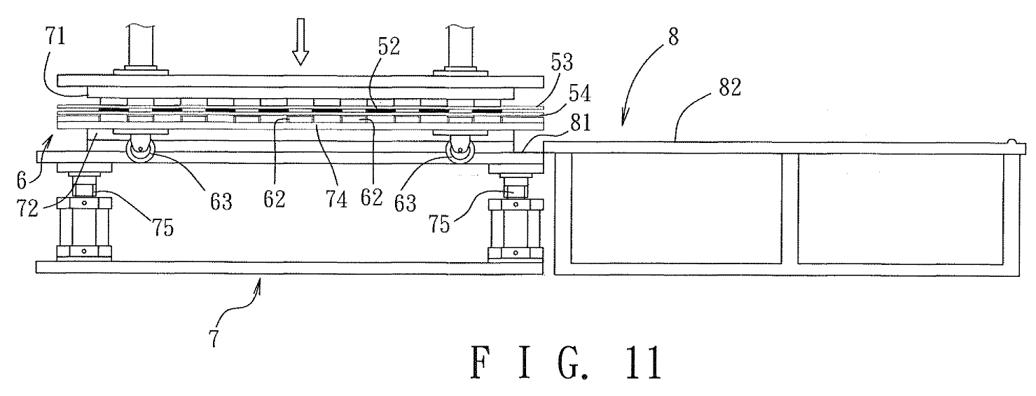

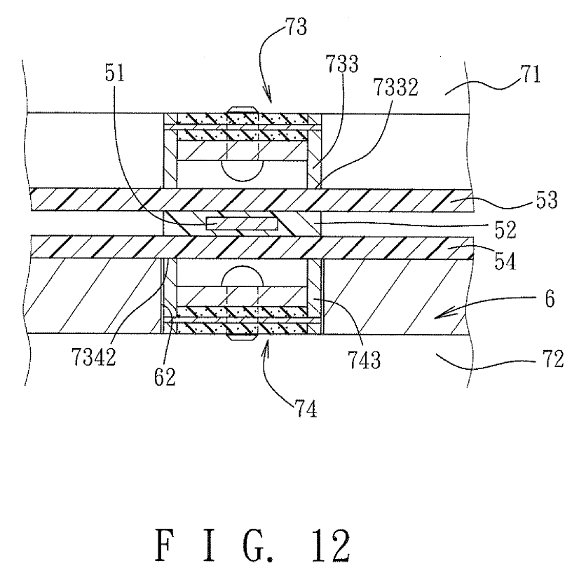

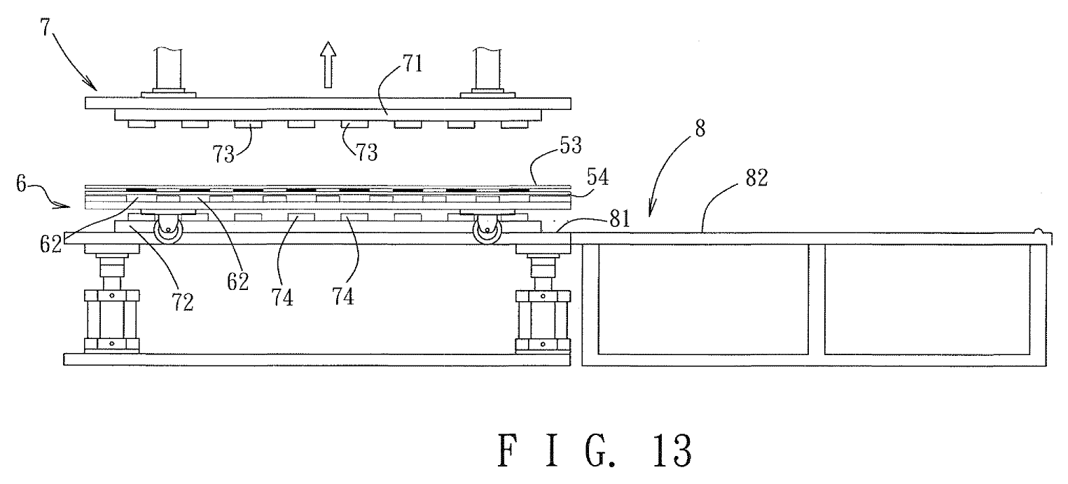

As shown in FIG. 9, the welding machine 7 includes upper and lower platens 71, 72, a plurality of upper dies 73 projecting downwardly from a bottom face of the upper platen 71, and a plurality of lower dies 74 projecting upwardly from a top face of the lower platen 72 and aligned respectively with the upper dies 73. The upper and lower dies 73, 74 are connected detachably to the upper and lower platens 71, 72. With reference to FIGS. 10 and 12, each of the upper and lower dies 73, 74 has a tubular member 733, 743, and a stack of first and second discs 731, 732, 741, 742 inserted fittingly into the tubular member 733, 743. The tubular member 733 of each upper die 73 has a top end 7331 connected to the upper platen 71, and a bottom annular press end 7332. The tubular member 743 of each lower die 74 has a bottom end 7431 connected to the lower platen 72, and a top annular press end 7432 alignable with the bottom annular press end 7332 of the corresponding tubular member 733. The first disc 731, 741 of each of the upper and lower dies 73, 74 is made of a foamed material, and has good shock-absorbing and deforming properties. The second disc 732, 742 of each of the upper and lower dies 73, 74 is made of a rigid material, such as metal or plastic.

A fastening pin 76 extends through the first and second discs 731, 732, 741, 742 of each of the upper and lower dies 73, 74 and into the respective upper or lower platen 71, 72 so as to fix the first and second discs 731, 732, 741, 742 to the respective upper or lower platen 71, 72. A transverse pin 734, 744 extends transversely of the fastening pin 76, and extends through the tubular member 733, 743 and the first disc 731, 741 of the corresponding upper or lower die 73, 74 so as to fix the first disc 731, 741 to the tubular member 733, 743. Each tubular member 733, 743 in this embodiment has a circular cross section, as shown in FIG. 10A. Alternatively, each tubular member 733, 743 may have an elliptical cross section, as shown in FIG. 10B, or an elongated ring-shaped cross section, as shown in FIG. 10C.

The platform 8 is disposed near the lower platen 72, and has a pair of first tracks 82. A pair of second tracks 81 are provided on two sides of the lower platen 72 so that the lower platen 72 is disposed between the second tracks 81. The second tracks 81 are aligned respectively with the first tracks 82. A plurality of actuators 75, preferably pneumatic actuators each having a pneumatic cylinder, are provided to hold the second tracks 81 so as to move upwardly and downwardly the second tracks 81 relative to the lower platen 72.

With reference to FIGS. 11 and 12, to carry out step 45, the carrier 6 is first moved from the first track 82 to the second track 81 so as to be disposed and positioned on the lower platen 72. The actuators 75 are then activated to lower the second tracks 81 relative to the lower platen 72 so that the tubular members 743 of the lower dies 74 extend into the respective through holes 62 and the top annular press ends 7432 thereof are in contact with the bottom plastic sheet 54. Afterwards, the upper platen 71 is lowered to the carrier 6 and the lower platen 72 so as to press the bottom annular press ends 7332 of the upper dies 73 and the top annular press ends 7432 of the lower dies 73, 74 against the top and bottom plastic sheets 53, 54 and the guide bars 51 so that top and bottom faces of the tubular tension members 52 are pressed between the top and bottom plastic sheets 53, 54. When the welding machine 7 is heated, high-frequency heat energy is transmitted to the upper and lower dies 73, 74 so as to weld the top and bottom faces of the tubular tension members 52 to the top and bottom plastic sheets 53, 54.

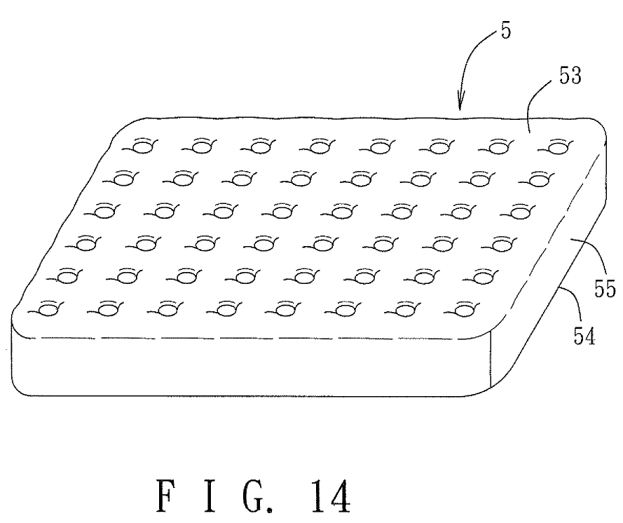

After the welding process, with reference to FIG. 13, the upper platen 71 is first moved upwardly and away from the carrier 6, after which the second track 81 is moved upwardly relative to the lower platen 72 so as to move the carrier 6 upwardly relative to the lower platen 72, so that the lower dies 74 are moved away from the respective through holes 62. Subsequently, the carrier 6 is removed from the high-frequency welding machine 7 by rolling along the second track 81. Each guide bar 51 is then removed from the carrier 6. Finally, top and bottom ends of a surrounding sheet 55 are welded respectively to peripheries of the top and bottom plastic sheets 53, 54 to form the inflatable bed 5, as shown in FIG. 14.

From the aforementioned description, the advantages of the method and system of the present invention for making the inflatable bed 5 may be summarized as follows:

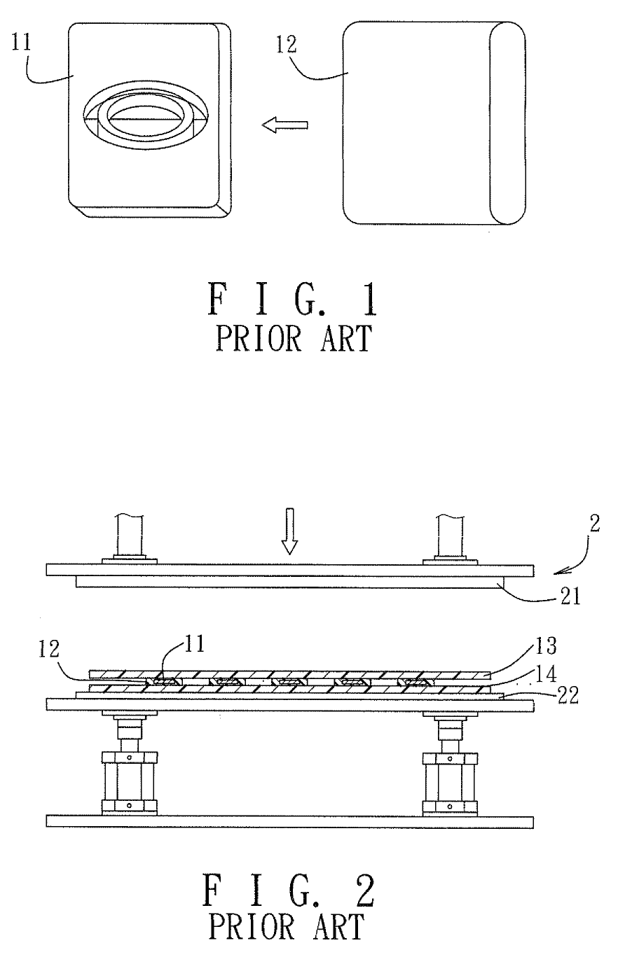

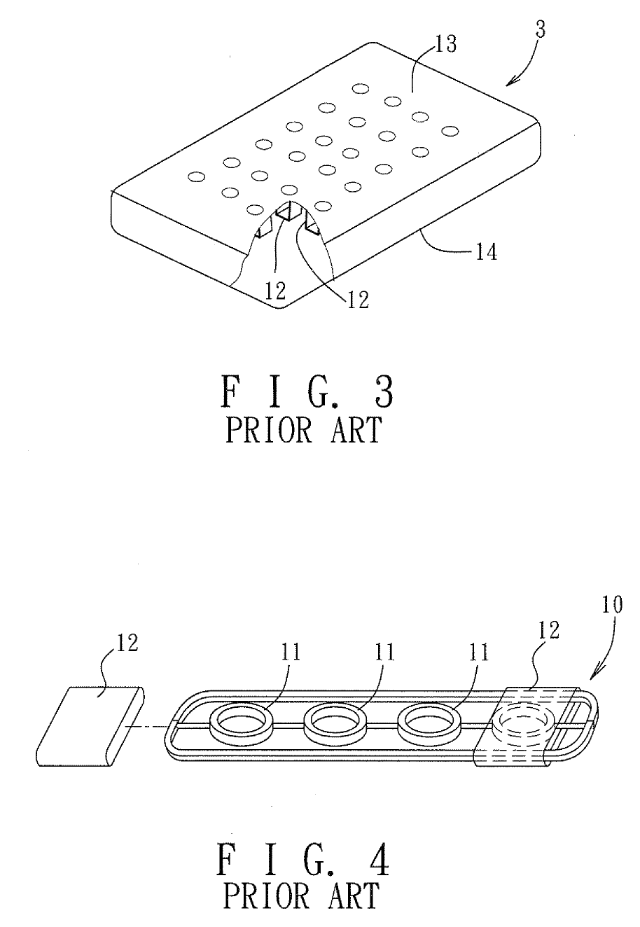

1. Since the carrier 6 is already provided with the aligned through holes 62 which are arranged equally spaced apart from each other, the tubular tension members 52, after being sleeved on the corresponding guide bar 51, are disposed aligned with and above the respective through holes 62, so that spacing among the tubular tension members 52 may be easily and accurately controlled, and positional deviation of the tubular tension members 52 may be avoided. This resolves the drawbacks encountered in the aforementioned conventional first and second methods for making the inflatable bed 3 where much time is consumed in conducting careful adjustment of the spacing among the tension members 12 (see FIGS. 1 to 4). Hence, the method and system of the present invention can enhance work efficiency.

2. Since the tubular tension members 52 can be arranged uniformly, the inflatable bed 5 made using the method and system of the present invention provides support for a user which is stable and uniform.

3. The method and system of the present invention uses the upper and lower dies 73, 74 to press the top and bottom plastic sheets 53, 54 and to weld the tensions members 52 to the top and bottom plastic sheets 53, 54 through high-frequency heat. Hence, patterns produced by the pressing of the upper and lower dies 73, 74 clearly appear on outer faces of the top and bottom plastic sheets 53, 54. That is, an entire surface of the inflatable bed 5 is provided with a uniform pressed pattern (see FIG. 14) which is clearly discernible, so that an appearance of the bed 5 is appealing.

4. Since the upper and lower platens 71, 72 of the high-frequency welding machine 7 are provided with a plurality of upper and lower dies 73, 74, and since the upper and lower dies 73, 74 are connected detachably to the upper and lower platens 71, 72, when one of the upper or lower die 73, 74 is damaged, the damaged upper or lower die 73, 74 may be replaced by first loosening the fastening pin 76, and then removing the transverse pin 734, 744. Therefore, it is not necessary to replace the entire upper or lower platen 71, 72 when one of the upper or lower die 73, 74 is damaged. Hence, repair costs can be reduced to a minimum.

5. The tubular member 733, 743 of each of the upper and lower dies 73, 74 receives therein the stack of the first and second discs 731, 741, 732, 742. The first disc 731, 741 is used for absorbing vibrations produced when the tubular members 733, 743 of the upper and lower dies 73, 74 press the top and bottom plastic sheets 53, 54. The second disc 732, 742 is used for enhancing stability of the tubular members 733, 743 so as to prevent the latter from deforming inwardly when pressed.

6. Through the use of the carrier 6 for holding the guide bars 51 and the tubular tension members 52, and through the use of the platform 8 which has the first track 82, the carrier 6 can be moved from the first track 82 to the second track 81 of the high-frequency welding machine 7, so that injury to the hand of an operator is not possible.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A method for making an inflatable bed, comprising:
sleeving a plurality of tubular tension members onto a guide bar;
placing a bottom plastic sheet on a carrier that has a plurality of aligned through holes extending through top and bottom surfaces of the bottom plastic sheet;
laying the guide bar on the bottom plastic sheet with the guide bar being aligned with the aligned through holes and with each of the tubular tension members being aligned with one of the through holes;
laying a top plastic sheet on the guide bar and the bottom plastic sheet; and
welding the tubular tension members to the top and bottom plastic sheets.

2. The method for claim 1, wherein the welding of the tubular tension members comprises:
providing a welding machine which includes an upper platen having a plurality of aligned upper dies projecting downwardly from the upper platen, and a lower platen having a plurality of aligned lower dies projecting upwardly from the lower platen;
disposing the carrier on the lower platen;
extending each of the lower dies into one of the through holes to contact the bottom plastic sheet;
lowering the upper platen to the carrier and the lower platen to press the upper and lower dies against the guide bar so that the tubular tension members are pressed between the top and bottom plastic sheets; and
heating the upper and lower dies.

3. The method for claim 2, further comprising:
providing a platform having a first track;
providing a second track on the lower platen;
moving the carrier from the first track to the second track so as to dispose the carrier on the lower platen; and
lowering the second track relative to the lower platen to move the carrier downwardly relative to the lower platen so that the lower dies extend into the respective through holes to contact the bottom plastic sheet.

4. A system for making an inflatable bed having top and bottom plastic sheets, and a plurality of tubular tension members disposed between and welded to the top and bottom plastic sheets, said system comprising:
a lower platen having a plurality of lower dies projecting upwardly from said lower platen;
an upper platen disposed above said lower platen and having a plurality of upper dies projecting downwardly from said upper platen and alignable with said lower dies;
a carrier to be disposed on said base, and having top and bottom surfaces, and a plurality of aligned through holes extending through said top and bottom surfaces, said carrier being adapted to support said top and bottom plastic sheets; and
a guide bar to be disposed on said carrier in alignment with said aligned through holes, said guide bar being adapted to extend into the tubular tension members;
said lower dies being extendable into said respective through holes when said carrier is disposed on said lower platen; and
said upper platen being movable downward and toward said carrier and said lower platen to press said upper and lower dies against said guide bar so that the tubular tension members disposed on said guide bar are pressed between said top and bottom plastic sheets.

5. The system of claim 4, further comprising:
a platform disposed near the lower platen and having a first track;
a second track disposed on said lower platen and aligned with said first track; and
an actuator connected to said second track to move upwardly or downwardly said second track relative to said lower platen;
said carrier being movable from said first track to said second track.

6. The system of claim 4, wherein each of said upper and lower dies has a tubular member, said tubular member of each of said upper dies having a top end connected to said upper platen, and a bottom annular press end, said tubular member of each of said lower dies having a bottom end connected to said lower platen, and a top annular press end alignable with said bottom annular press end.

7. The system of claim 6, wherein said upper and lower dies are connected detachably to said upper and lower platens.

8. The system of claim 7, wherein each of said upper and lower dies further has a stack of first and second discs inserted fittingly into said tubular member, a fastening pin extending through said first and second discs and into said upper or lower platen, and a transverse pin extending transversely of said fastening pin and through said tubular member and said first disc.

9. The system of claim 8, wherein said tubular member has a circular cross section.

10. The system of claim 8, wherein said tubular member has an elliptical cross section.

11. The system of claim 8, wherein said tubular member has an elongated ring-shaped cross section.

12. The system of claim 4, wherein said guide bar has two opposite ends respectively provided with first engaging elements, and said carrier has a plurality of second engaging elements respectively engageable with said first engaging elements.
